(19) United States
(12) Patent Application Publication
(10) Pub. No.: US 2016/0314459 A1
(43) Pub. Date: Oct. 27, 2016

(54) GLOBAL DIGITAL ENERGY CURRENCY

(71) Applicant: Ali Naghi Jamali Mazlaghani, Berlin (DE)

(72) Inventor: Ali Naghi Jamali Mazlaghani, Berlin (DE)

(21) Appl. No.: 15/139,614

(22) Filed: Apr. 27, 2016

Related U.S. Application Data
(60) Provisional application No. 62/152,995, filed on Apr. 27, 2015.

(51) Int. Cl. G06Q 20/36; G06Q 50/06; G06Q 20/06; G06Q 10/00; G06Q 40/06; G06Q 20/38

(52) U.S. Cl. CPC G06Q 20/3672; G06Q 40/06; G06Q 20/381; G06Q 20/065; G06Q 10/30; G06Q 50/06

(57) ABSTRACT

A system and method for generating a world currency using the kilowatt energy produced by renewable energy power plants (REPP) where one kilowatt hour energy (kWh) is equivalent to one unit of the world currency called global digital energy currency (GDEC). To generate the GDEC, citizens and investors deposit their paper currency into system owned banks (SOBS) which are processed by a central converting and accounting system (CCA) connected to the SOBS and the REPP. The CCA converts the paper currency of the citizens and investors into GDEC and distributes them to the electronic wallets (EW) of the citizens and investors to buy goods and services so that the GDEC is transferred to new citizens who inherit the currency and eventually spread the GDEC throughout the economy. The CCA uses an encrypted code to link the investors and the renewable energy power plants so that they are traceable.

### CROSS REFERENCE TO RELATED APPLICATION

This Non-provisional Patent Application claims priority to U.S. Provisional Patent Application No. 62/152,995 Titled, Global Digital Energy Currency filed Apr. 27, 2015 which is incorporated herein in its entirety.

### FIELD OF THE INVENTION

The present invention is generally related to currencies. More particularly, the invention relates to the concept of a world currency in the form of a digital currency called, global digital energy currency.

### BACKGROUND OF THE INVENTION

By current estimates, the total number of official currencies circulating around the world is roughly, one hundred and sixty seven. The need for a common World Currency Unit (IA/CU) was first promulgated during the Great Depression that followed World War II and has since been debated over the years. A form of World Currency called SDR (Special Drawing Right) was created in 1969 by the International Monitory Fund (IMF) as a means to supplement the official reserves of its member countries and to settle trade balances between countries and/or repay the IMF. The value of the SDR is based on a basket of four international currencies, the US dollar, British pound, Euro and the Japanese yen and the SDR's can be exchanged for only those currencies. A drawback of the SDR is that citizens of a country do not hold these currencies nor are they capable of using them. As such, they represent an illiquid and imperfect asset, held and used by only the IMF itself and the IMF member countries.

There is a need for a single global currency that is accessible to the citizens of each country and which eliminates the need to exchange their currencies with currencies of other nations when traveling, buying and selling goods or transacting business across their borders. The current invention for a Global Digital Energy Currency (GDEC) enables the energetic transformation and recycling of the various paper and/or fiat currencies used around the world to a single World Currency enabling the citizens, corporations and governments all across the globe to transact business using a common currency.

### SUMMARY OF THE INVENTION

The aim of the present invention is to create a World Currency in the form of a Global Digital Energy Currency (GDEC) through investments in Renewable Energy Power Plants (REPP). The business model of the invention is based on a recycling and transforming tool for converting paper/fiat currency into a traceable, tangible and fraud-proof, global currency, called, GDEC.

The important entities and tools for the implementation of this invention are:
1. Citizens. As Consumers and Investors in GDEC.

### 2. System Owned Banking System (SOBS).

### 3. Central Converter and Accounting System (CCA).

4. Electronic Wallets (EW) as credit cards of future users of the Global Digital Energy Currency (GDEC).

### 5. Renewable Energy Power Plants (REPP).

6. Kilowatt hour (kWh) energy units.
7. Electricity Consumers connected to public or to autonomous community grids.

### 8. Independent Energy Agencies (IEA)

9. Inheritance Principle (IP) resulting from transactions between the GDEC holding community and the Marketplace.
10. Traceability Principle (TP) as a result of the Retailer and Service Industry acceptance of GDEC units as currency on their payment platforms.
11. Energy Tags in different colors: Green, Yellow and Red.

### 12. Energy Audit System (EAS).

13. Invention related applications (Apps) for Smart devices.
14. Fossil fuel to renewable energy: Proposals and ideas for converting fossil fuels before they are burnt to CO2 through Fossil Fuel Processing Plants (FFPP) and converting them to GDEC units.
15. Turning gambling to REPP projects: Idea for transformation of negative socio-economic energy such as gambling to environmentally positive and profitable projects such as, REPP projects, with GDEC units as the end product.
16. Online Auction and Trading platforms for GDEC units.
17. Solar Parks as future communities and cities set up according to Green and Renewable Energy standards.
18. Construction of factories and buildings based on Renewable Energy power.
19. Alternative Mobile payment system.
20. System introduced ATM machines for exchanging GDEC units against gold, silver and other rare metals.

The primary object of the present invention is to provide a stable, inflation-resistant, encrypted and traceable world currency and eliminate and/or minimize the need for the use of inflation prone, paper/fiat currencies and the flaws associated with them such as, un-traceability and the potential for the generation of fraudulent currency.

In the exemplary embodiment of the present invention, the traceable world currency is in the form of a Global Digital Energy Currency (GDEC). In this embodiment of the invention, the value of 1 unit of the GDEC is equal to one kilowatt hour (1 kWh) energy produced as the end product in a Renewable Energy Power Plant (REPP). A, kWh is a globally used commodity measuring unit, which makes it a tangible and understandable unit of measurement for almost all world citizens and therefore, easier for all world currencies, energy units, securities and all other financial products to be converted to the GDEC units.

Another object of the present invention is to invest the currently circulating paper currencies of the world into Renewable Energy Power Plant (REPP) projects which in turn generate the kWh energy that comprise the units of the GDEC. The Renewable Energy Power Plant (REPP) is the productive part of the concept and can be defined as the kWh energy or GDEC unit mining factory. It is also a recycling factory to recycle the inflation and fraud-prone paper/fiat currency into real value commodity as future GDEC units. The production and mining of every kWh energy unit or GDEC unit means turning the non-traceable inflation prone paper/fiat currency to a truly traceable digital currency matched to a traceable and encrypted code. Renewable Energy in kWh energy unit or GDEC unit according to this model is a real, tangible, traceable and convertible commodity, which the economies can produce and establish as a stable digital currency. The concept of the invention is based on the principle that the real value within an economic system should be first created and produced before it can be spent.

The produced kWh energy from the REPP are mined/collected and encrypted through a Central Converting and Accounting (CCA) system and distributed to the Electronic Wallets (EW) of the investors and citizens in the form of GDEC units. By doing so, more and more unstable, inflation and fraud-prone paper/fiat currencies can be transformed to a global, inheritable and traceable, digital currency such as the GDEC.

Yet another object of the present invention is to protect the environment by reducing the carbon foot print through the use of renewable energy from power plants. Different fossil fuels can be converted to GDEC units before they can produce carbon dioxide (CO2), by creating capacity to process them in special Fossil Fuel Processing Plants (FFPP).

In all embodiments of the invention, the world currency in the form of GDEC initially exists parallel to the established paper/fiat currencies and functions as a recycling and transforming tool for those currencies to make them inflation and fraud-proof before they begin to function as fully traceable green energy, GDEC units. GDEC is not intended to compete with any established world currencies but to make them more inflation and fraud proof. The business model of this invention is fully transparent and capable of cooperation with all national and international entities, national and international banks and governments worldwide. However, if some countries, governments, world bodies and entities try to impose their will, influence and limiting regulations on the business model of the invention, then this business model can be adopted by one or many countries to introduce their own GDEC units rather than being dictated by other governments and world bodies and their currencies. At least 3% of the cost for setting up the business model of the invention comes from investors and the rest from donations to help weaker members of the society become investors and take part in the economy. The invention intends to move the economy away from interest based investments to a profit oriented economy.

In the exemplary embodiment of the invention, citizens of a country invest in Renewable Energy Power Plants (REPP) and along with the private sector comprise 75% of the shareholders in the REPP projects and hold 75% of the GDEC units. By investing directly in REPP projects, the citizens will have a higher profit margin than what they can garner from Corporations. In this embodiment of the invention, Governments, Banks, Insurance companies and Corporations comprise 25% of the shareholders and own 25% of the GDEC units. If the investment activity of the citizens at any given period is low, Corporations and Governments will be allowed to own a higher share in any planned REPP projects. The mined GDEC units will be distributed among all investors at the end of each quarter beginning with the end of the first quarter after the amortization time of the REPP.

The digital currency of the invention, GDEC is inherently interconnected with the Inheritance principle (IP), Traceability and Energy Tags and in direct connection with all goods and services within the economy, leading to a full inventory of all branches of the economy. The essence of the Inheritance Principle lies in the exchange of ownership of the GDEC units to bring in new owners and new investors into the REPP projects to spread the GDEC units further within the economy. In order to intensify the widespread use of the GDEC units, different businesses in all branches of the economy can and will be defined and introduced. And finally, double digit net profit of all businesses will be invested in REPP or FFPP projects under the investors/customers name. Thus, the system defined businesses will be the first to introduce and accept the GDEC units on their payment platforms. The other concept developed through this invention is the Traceability principle (TP) based on the fact that if energy cannot be destroyed but can only change its form, then GDEC units as equivalent to kWh energy units should follow the same principle of not being able to be destroyed and capable of being traced. As energy can be traced and quantified on its changing path, GDEC units should be traceable, too. Encryption of GDEC units is a very central issue for the realization of traceability. The owners of the Electronic Wallet (EW) are traceable through their encrypted GDEC units. Without encryption, the traceability of the GDEC units through the economic activities would be very difficult or nearly, impossible. Traceability can be implemented on GDEC units as future global currency and deliver positive results, if the retailers accept them as a legitimate currency and exchange data over the barcode or Energy Tags of goods and articles with the Central Converter and Accounting System (CCA). Therefore, the degree of success of traceability correlates directly with the degree of acceptance of GDEC units through retailers. The special codes given to GDEC unit accounts function as electronic signatures and this electronic signature combined with the data exchange with retailers and seller of goods and services enable the actions and behaviors of the owners of the signatures to be followed within the economic system. The less paper/fiat currency for transactions are accepted, the more successful this business model would be.

Another object of the business model of the invention is to plan and create fully autonomous Solar Parks with 100% reliance on REPP's and with full integration of all Renewable Energy related infrastructures which an autonomous community needs. In the beginning of this business model there will be a few REPP projects, but with time, their number is predicted to increase and a net number of REPP projects will be built. Accordingly, the number of energy consumers near every REPP project will grow and keep consuming the energy produced in these power plants.

The foregoing summary of the objects and embodiments of the present invention should not be construed to limit the scope of the invention. In this summary of the invention and in the specification in general the various references to “the exemplary embodiment” “related embodiment” or “yet another embodiment” do not necessarily refer to the same embodiment (s). Rather, these references to the various embodiments in general mean that a particular feature, structure, or characteristic described in conjunction with an embodiment is included in at least some embodiments, but not necessarily all embodiments of the invention.

The objects, embodiments, and features of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is an overview of the general functioning of the present invention.

FIG. 2 is a continuation of the general functioning of the invention overview.

FIG. 3 is a flow chart showing the GDEC in action in the marketplace and the essence of the Inheritance Principle.

FIG. 4 is a flow chart describing retailer participation through acceptance of GDEC as the currency and their traceability.

FIG. 5 is an overview of Energy Tags as a transparency measure and an exercise for the consumers to get accustomed to the new GDEC units as the currency.

FIG. 6 is an overview of the conversion of Fossil fuels to GDEC units.

FIG. 7 is an overview of the role of the CCA in linking investors in FFPP to the REPP projects.

FIG. 8 is an overview of the re-cycling concept of the invention.

FIG. 9 is an overview of the technical infrastructure of the system.

### DETAILED DESCRIPTION OF THE INVENTION

The present invention is a radical and pragmatic approach to creating a World Currency system which eliminates the use of paper currency and replaces it with a common digital currency that can be used in all financial transactions around the globe between individuals, entities and countries. The primary aim of the invention is to convert paper/fiat currency into a traceable, tangible and fraud-proof, global currency called Global Digital Energy Currency (GDEC). The primary avenue for accomplishing this goal is through investments in Renewable Energy Power Plant (REPP) projects. The value of 1 unit of the GDEC is equal to one kilowatt hour (1 kWh) energy produced as the end product in a Renewable Energy Power Plant (REPP).

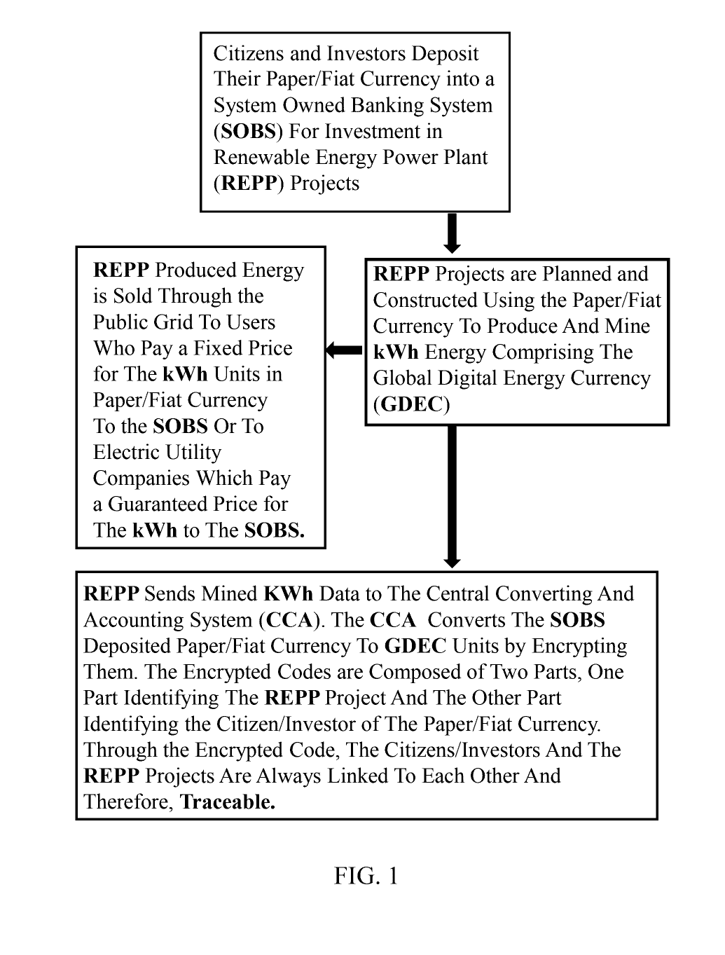

Referring now to the drawings, in particular FIG. 1, this figure is an overview showing the general functioning of the system of the invention. In the exemplary embodiment of the invention, citizens and other investors deposit their paper/fiat currency into a System Owned Banking System (SOBS) for the purpose of investing in a REPP project. The REPP projects are then planned and constructed using the paper/fiat currency deposited by citizens and investors to generate the kWh energy units of the GDEC. The, REPP projects send the mined kWh energy data to the Central Converting and Accounting System (CCA). The CCA converts the SOBS deposited paper/fiat currency to GDEC units by encrypting them. The encrypted codes are composed of two parts, one part identifying the REPP project and the other part identifying the citizen/investor of the paper/fiat currency. Through the encrypted code, the citizens/investors and the REPP projects are always linked to each other and therefore, Traceable. All details of the personal data of investors will be protected and will not be shared, but the investors have the option to publish any information they want.

The consumer of energy coming from REPP can be at the same time, shareholders and investors of that REPP. They can pay with paper/fiat currency as well as with GDEC units using their electronic wallets (EW). Because of the high profit margin of mined GDEC units, the energy consumers may tend to pay their bill in paper/fiat currency. If they pay their electricity bill with paper/fiat currency to the SOBS, the CCA converts them into kWh energy units and further into GDEC units and collects them for the next quarterly distribution among the investors and citizens in the form of encrypted GDEC units. If they pay their bills with GDEC units, three different consequences could occur. A) The CCA offers a double digit percentage of the same GDEC units again to the old owner as an incentive to keep spending the GDEC units. If he agrees to buy them, then the same GDEC units will be transferred to his/her wallet against the payment of an equal amount, in paper/fiat currency. B) If he/she does not want to have them, then the CCA decodes the GDEC units to kWh energy units and those who are ready to invest in the system will acquire them. Here priority is given to outsiders who don't have any shares in any REPP projects. By doing so, the number of GDEC unit users will grow faster. In the next step, the CCA will again generate a new encrypted code for the new owner and register him/her as a new shareholder of the project. The new shareholder inherits the GDEC units. C) The CCA decodes the GDEC units into kWh energy units but finds no investors. The decoded kWh energy units will be accumulated together with other generated kWh energy units and at the end of the quarter will be distributed in the form of encrypted GDEC units among the shareholders.

The REPP produced energy is sold through the public grid to users who pay a fixed price for the kWh energy units in paper/fiat currency to the SOBS or to Electric utility companies which pay a guaranteed price for the kWh energy units to the SOBS. The energy consumers are normally connected to public or autonomous community grids. They consume the enemy produced in REPP projects and pay their bill in paper/fiat currency to the REPP owner company, which would have adopted this invented business plan. They pay their utility bill to the electricity companies and the price for produced kWh energy produced in REPP are guaranteed through a state energy program for a certain period of time. The existence of a governmental guaranteed energy purchase program is also a necessary condition. Most developed countries have set up such environmental programs and others would follow. If in some countries, similar state guaranteed programs do not exist and if the consumer wishes to use the energy produced in REPP projects, then the energy users have to sign a contract with the owners or runners of REPP projects who adopted this business plan. They have to sign utility contracts with the owner of the REPP project. The payment of their bill can be organized in two ways according to the online banking system of the company, SOBS, or in the case of an external bank, paying the bills through any other bank and sending the receipt to the company for further processing.

For autonomous communities with their own electricity or energy grid, it is important, that for the use of the full capacity of each REPP, enough consumers should be available to consume the produced and mined kWh energy units and pay their bills in fiat currency or in GDEC units. In this case, the system recycles the maximum amount of fiat currency into kWh energy units or GDEC units. Produced but not consumed energy decreases the efficiency of that particular REPP, especially in developing and third world countries if the state doesn't buy the energy produced in REPP projects. Installing mobile high-density storage systems combined with smart energy management systems to distribute the energy to where it is most needed, can solve this problem. The mobile storage systems can also be transported to the points needed. Here, an active marketing strategy will be needed. Early smart warning systems will be introduced to remind the consumer during the day about proper consumption of energy. Fuzzy logic and neural networking can help the development of such smart communication software.

Another option for increasing the efficiency of REPP is to sign contracts with utility companies and sell the stored but not needed kWh energy units to them. This is the usual practice in developed countries with state energy purchase programs. In most developed and industrial countries this is not the case anymore due to connection of REPP projects to the community or city grid. The REPP projects feed their excessive energy or all produced energy to the public utility grid and get paid through the state utility company according to an agreed fixed price for every kWh energy unit. If the governments guarantee these programs, the utility companies have the obligation to follow them.

In the embodiments of the present invention, the fiat currency value of GDEC units distributed to the investors in the REPP projects is fixed as 1 kWh energy for a period of one year through the Independent Energy Agency (IEA) authorities. The most important task of the IEA is to set the price for every new calendar year by evaluating the market and the state of the technical progress and its reflection on price building process in the energy field. This fixed value for one year, allows stable calculations for businesses and households and eliminates the inflation effect for that time period and for that paper/fiat currency. Depending on renewable energy source, the value of 1 kWh energy and in turn the value of the GDEC units can change from year to year according to the new fixed value for 1 kWh energy produced. The GDEC is capable of being divided into decimal points to allow and guarantee exact economic calculations. The yearly changed and fixed energy prices will be the basis for transactions within and beyond the borders of a country.

To have reliable data, the IEA needs to be connected to every energy project as an energy producing unit. The Central Converter and Accounting system (CCA) exchanges related data about REPP with the IEA, online. IEA agencies will constantly track the state of technical development in the market as well as price development for REPP parts. Together with inflation and estimated energy demand on the market, they will set a new price for produced kWh energy units. The IEA agencies can work together with state energy agencies on price building process in direct cooperation, or as advisors. The IEA can execute the examination process on its own or together with the recognized and independent audit system authorities by exchanging data with them.

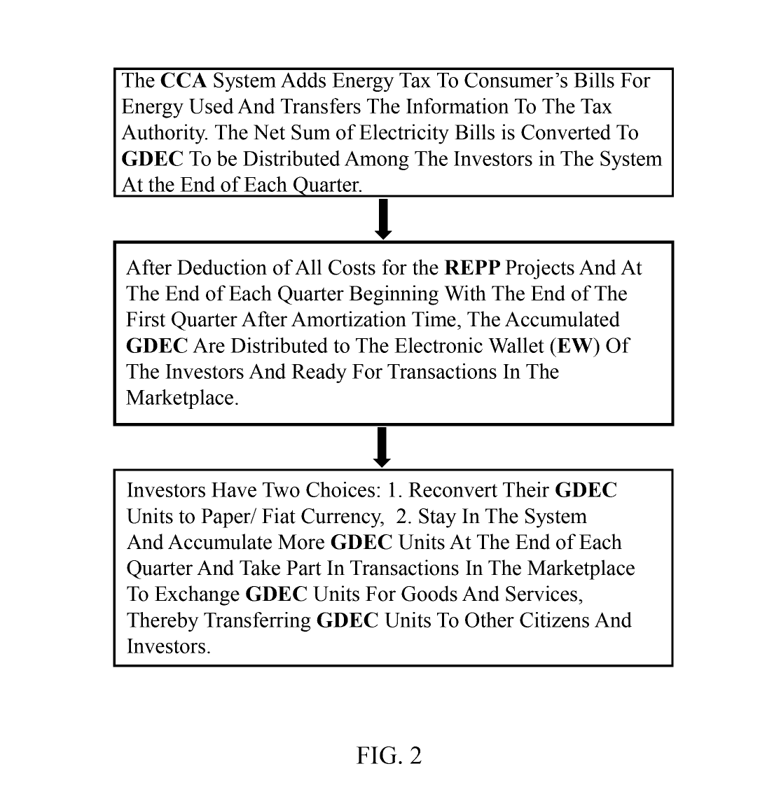

FIG. 2 is a continuation of the general functioning of the invention overview and explains the functioning of the Central Converter and Accounting System (CCA) further. The CCA system adds energy tax to the consumer's bills for energy used and transfers the information to the tax authority. At the end of each quarter, the net sum of electricity bills is converted to GDEC units to be distributed among the investors in the system. Further, at the end of each quarter beginning with the end of the first quarter after the amortization time, after deduction of all costs for the REPP projects the accumulated GDEC units are distributed to the electronic wallet (EW) of the investors and ready for transactions in the marketplace.

Once the investors in the REPP projects have the GDEC units distributed in their Electronic Wallet (EW), they have two Choices: 1) Reconvert their GDEC units to paper/fiat currency, or 2) Stay in the system and accumulate more GDEC units at the end of each quarter and take part in transactions in the marketplace to exchange GDEC units for goods and services, thereby transferring their GDEC units to other citizens and investors.

The System Owned Banking System (SOBS) is connected to the Central Converter and Accounting system (CCA) as well as the National and International Banking systems. For investment in any REPP project, a special code is needed which clearly identifies every REPP project. The code is given through the CCA system and a list of the codes and their corresponding REPP projects are listed on the Main website or on the online Banking section of the website. There is a tight connectivity between the CCA system and SOBS. The system does not allow access to online external banking sites. However, if necessary, access to online banking can be made available through a separate website. Invested money as deposited in SOBS cannot be lent or used for any other purposes except invention related businesses with the end target of mining and introducing the GDEC units. Of all the transaction fees collected when banking with the SOBS, only between 1 and 1.5 percent will be raised and generally kept lower than any other existing financial institutions and will be primarily used for the cost of running the system.

The Electronic Wallets (EW) function as online credit cards for future GDEC units. Investors can go online, login and have access to their accounts immediately using their EW. They can buy products from sellers and retailers who offer GDEC units as currency on their platforms, after these sellers and retailers have opened an account for their company and acquired one or more wallets in order to be able to execute successful transactions with customers. Other actions the wallet owner can execute are: 1) Investing in new projects, 2) direct real time contact to CCA and SOBS, 3) taking part in auction for trading GDEC units, 4) full access to important social media platforms to exchange opinions and stay up to date, 5) transfer GDEC units to other users to enable them to participate in GDEC community and much more. Different encrypted codes with corresponding numbers of GDEC units can be listed on one EW. The owner of an EW can select each of the listed accounts to initiate the transaction to other EW owners as members of the user community. The investor or customer can also distribute his/her GDEC units to different EW's. Biometric recognition software may be used to recognize individual investors in the system.

The REPP's provide higher profit margins for all investors and a short amortization time for the REPP's. These higher profit margins combined with the short amortization time of the REPP will allow cashing in within as little as 21 months after the construction of the REPP with rising profit margins for the coming years. The short amortization time allows for the distribution of the GDEC units at the end of each quarter to the investor's Electronic Wallets (E % V) which is especially beneficial to those in the lower socio economic brackets and to increase their standard of living.

In the embodiments of the invention, before a bank account for investment in REPP projects can be opened, the investors must agree to certain Terms and Conditions of the business model. Some of these important Terms and Conditions include, for example:
A. According to the Inheritance Principle (IP), spending 30% of quarterly distributed GDEC units during the first 3 years after the first distribution to Electronic wallets (EW) in the marketplace by transferring them to other members of the community like Retailers, Seller or others. The measuring period for their spending through the CCA is 6 months and might change according to conditions.
B. Agreeing to reinvest 15% of earned GDEC units back into the construction of further REPP projects.
C. Accepting the investor composition of 75% Citizens and 25% to Corporations, Banks and Governments.
D. For external REPP construction companies to reinvest 10% of after tax amount of fiat currency into construction of new REPP projects.
E. Agreement to submit biometric data to the system if needed.
F. NOTE: Additional Terms and Conditions may be introduced to facilitate the smooth operation of the business model of the invention. For example, one condition may be that some percentage of invested money through the investors should remain in the SOBS as guarantee for investors. Another Terms and Condition that may be introduced might be, the limitation of shares an investor can hold in a REPP project, due to the high number of investors. Yet another Terms and Conditions would be that the investors must agree that they will not invest in any toxic assets to affect the flourishing of the recycling principle.

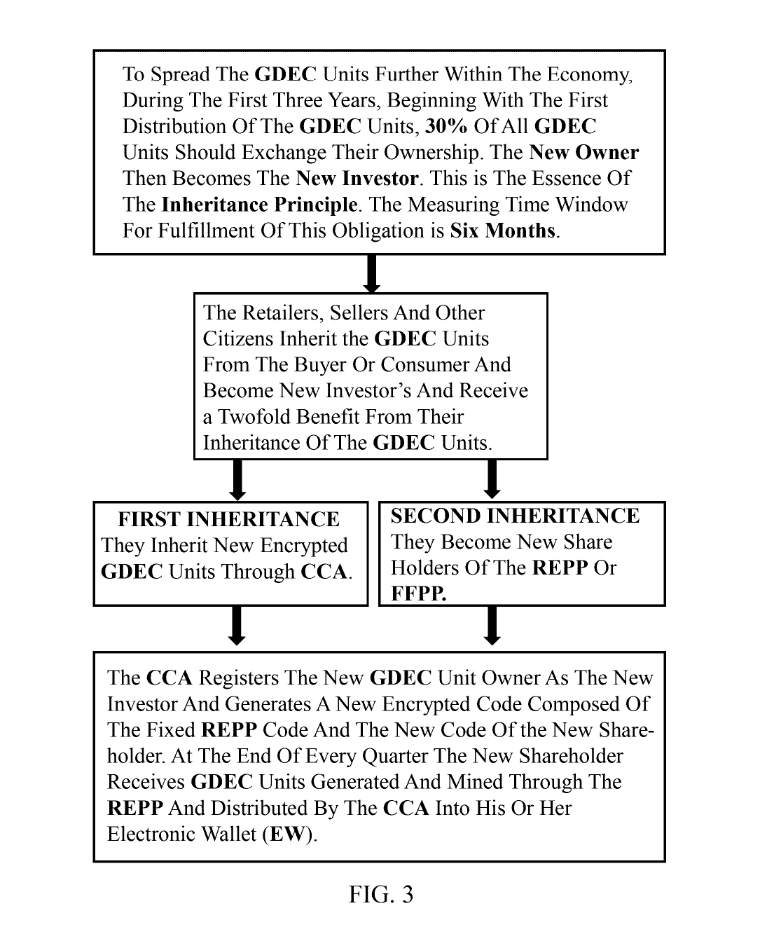

FIG. 3 is a flow chart showing the GDEC in action in the marketplace and the essence of the Inheritance Principle (IP). The Inheritance principle is a result of the transaction between the GDEC community and the Marketplace. During the transaction of GDEC units between the buyers and retailers or service industry, the GDEC units are transferred through buyers to sellers or retailers. According to the inheritance principle (IP), the new owner of GDEC units as seller or retailer becomes a new investor and according to the number of GDEC units they possess, will profit from the quarterly distributed GDEC units. The energy currency units in the beginning phase of REPP are accumulated in electronic wallets (EW). But at some point, the owner of GDEC units may want to interact with the marketplace and spend them in exchange for goods and services. Due to the high profit margin in this invention and due to the multiplication character of GDEC units through REPP for many years to come, it is very unlikely that the investors and owners of GDEC will reconvert them to fiat currency, which allows the GDEC units to remain in the system. On the other hand, the GDEC units should circulate at least partially in the marketplace and multiply the number of GDEC owners. Therefore, a 30% transaction obligation of quarterly earned GDEC units during the first 3 years of the REPP activity is built into the business model of this invention. This obligation will increase the number of investors who will profit from this system and create new future consumers. It is also an incentive for the retailer and seller to accept these GDEC units as legitimate currency along with the other accepted currencies. The new owners of GDEC units have the free choice to remain in the system as investors due to the high profit margin or reconvert their GDEC to fiat currency through the CCA. In order for this system to work, all participants must have at least one electronic wallet (EW). They can apply for that on the website of the company by submitting a new account and obtaining their wallet.

The technical steps of the inheritance principle (IP) happen in the CCA. A new encrypted code for a new owner of the GDEC units is created by leaving the REPP code untouched and giving a new code to the new owners of the GDEC units. Through the new encrypted code provided by the CCA, the new owner is identifiable for the system as an investor and shareholder in the REPP project so that at the end of each quarter he/she as well as other investors receive new amounts of GDEC units in their electronic wallets (EW). This instrument is introduced for mainly three reasons: First, it should help for the faster spread of the GDEC units among the communities. If it were left to the investors alone, they would tend to accumulate rather than to spend the GDEC units and this would go against the principle of this business model. Second, this measure will have an advertising effect on those who are not familiar with the system, especially on retailers and sellers of goods. Third, and most importantly, it is crucial to have a sense of sharing of the wealth with other members of the community. During the first three years, beginning with the first distribution of the GDEC units, 30% of quarterly distributed GDEC units should exchange their ownership. The new owner then becomes the new investor. The measuring time window for the fulfillment of this obligation is six months. The new investors receive a twofold benefit from their inheritance of the GDEC units: 1) As a First Inheritance, they inherit new encrypted GDEC units through the CCA, 2) As a Second Inheritance, they become new shareholders of the REPP or Fossil Fuel Processing Plants (FFPP). The CCA registers the new GDEC unit owner as the new investor and generates a new encrypted code composed of the fixed REPP code and the new code of the new shareholder. At the end of every quarter the new shareholder receives GDEC units generated and mined through the REPP and distributed by the CCA into his or her Electronic Wallet (EW).

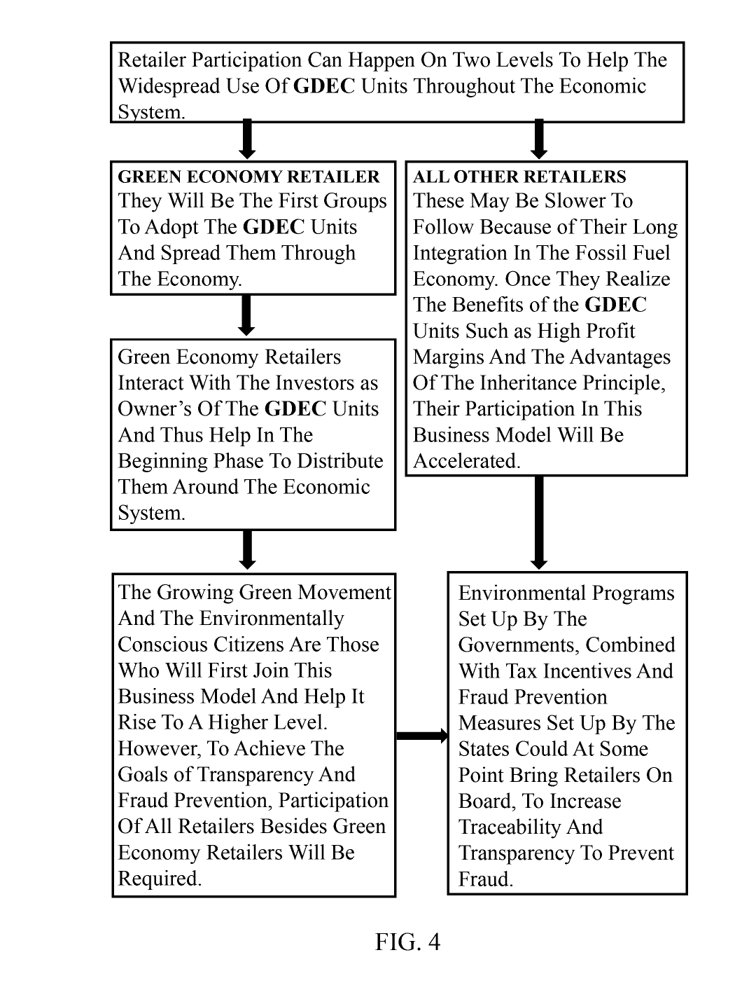

FIG. 4 describes the two levels of retailer participation in the system. It is anticipated that the use of the business model of the invention would begin with the green and environmentally conscious parts of the populations of each country and would eventually spread further to other parts of the economy and other countries due to the urgent actions needed for the sake of preserving our environment. Citizens who are environmentally conscious will be among the first investors in this business model to accept the GDEC units on their payment platforms and through their initial investment in REPP projects. It is hoped that the other players and participants in the economy will follow their lead. Incentives like high profit margin and the Inheritance principle (IP) combined with more freedom of choice for retailers, will have a positive impact on the mindset of the retailer and seller to adopt the use of the GDEC units. The implementation of retailer data exchange with CCA for green products will take place faster than for regular products, initially. A broader participation of all other retailer branches will follow when they observe the high profit margins distributed among the investors combined with the advantages of the IP. Environmental programs set up by the governments, combined with tax incentives and fraud prevention measures set up by the states could at some point bring retailers on board, to increase traceability and transparency to prevent fraud. The existing Block chain Technologies or adapted variations of them could be used to register and trace all transactions between the GDEC community and the retailers. Further, different contracts within and outside the GDEC community can be signed and registered through Block chain Technology and its software.

To add further incentive, the business model of the invention introduces a rule to bring retailer, seller and exchanger of this GDEC on board. This rule allows any receiver (seller, retailer or any other participant in the economic activities) of the GDEC units to exchange them immediately against the fiat currency by sending a request to the CCA. The CCA then sends a request to the bank and the amount of fiat currency is transferred to the corresponding account of the retailer or trader. The sellers and retailers or any other user of GDEC units also have the opportunity to save this option in their account profile in the SOBS and CCA, so that after every transaction, the amount in fiat currency will be sent to their bank account automatically. Distribution of high profit margins and the Inheritance principle (IP) will keep the new owners of the GDEC units, within the system. The primary goal of this obligatory rule is to increase the number of GDEC owners as future participants in market transactions while at the same time, bring more and more retailers on board. The worst consequence of the inheritance principle (IP) for the old owner of GDEC units is their acceptance by new owners or retailers. The new owners will become new investors and will profit from the generated GDEC units through the remaining life of the REPP project, while the old owners will be partial losers of this principle. The old owners are considered only partial losers because of the fact, that they are still winners through owning 70% of all GDEC units in their wallets. The 30% transaction obligation constitutes no disadvantage at all for the old investors, as there will be enough opportunities for them to invest in new REPP projects and compensate their loss.

If the retailer or seller of products or any participant in the economic transactions should decide to convert the GDEC units to fiat currency, it can be accomplished in several ways. However, the ultimate goal is to bring the GDEC units back into the system and close the escape paths for them to leave the system. The main aim of the business model is to transform and recycle as much of the fiat currency as possible and convert them to the highly traceable GDEC units so that they remain within the system. States can compete with each other by offering better investment environment for their own citizens as well as for the citizens of other countries so that the investors of one country can invest in the REPP projects in other countries. The states who offer such investment programs to citizens and investors of other countries, agree to accept the earned GDEC units of investors from partner countries in their retailer payment platform or guarantee to exchange them in fiat currency through their CCA and SOBS according to terms and conditions of this business plan. At the time of shopping or transaction in partner countries, the value of the GDEC units will be calculated according to the fiat currency exchange rate of those countries. The produced and mined kWh energy units can be sent to their EW's and spent in the countries which have introduced the GDEC. The GDEC units can be spent in countries with common investment projects as well as in all other countries which adopt this business model.

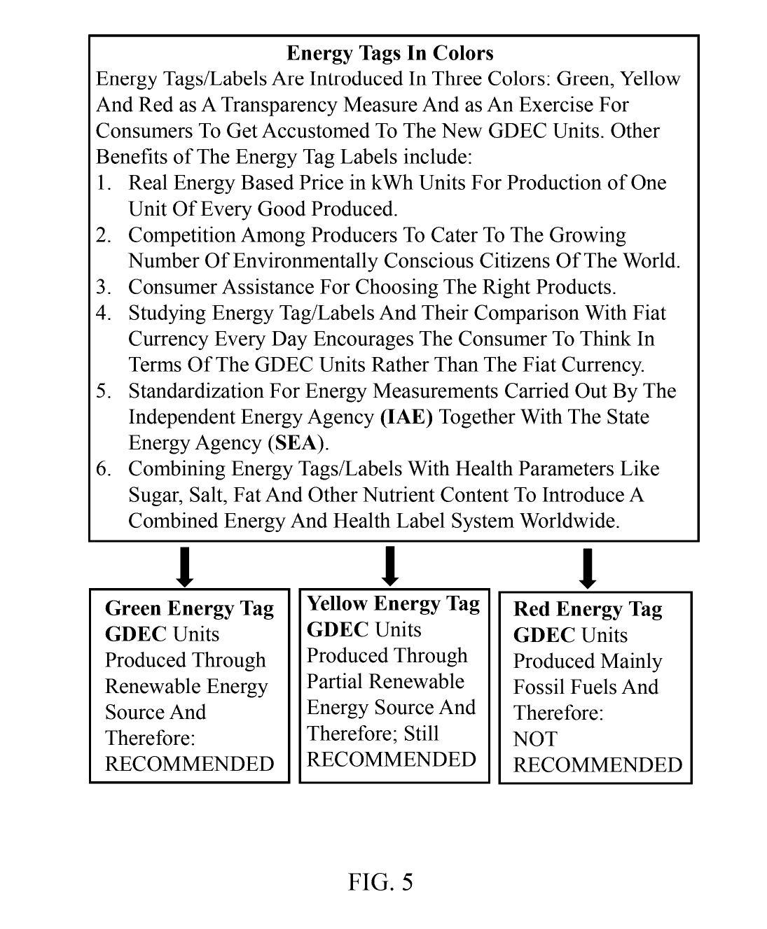

FIG. 5 describes the use of Energy Tags as part of the labeling of packaged goods. Energy Tags/Labels are introduced in three colors: Green, Yellow and Red as a transparency measure and as an exercise for consumers to get accustomed to the new GDEC units. Trademarks for the energy labels on packaged goods will comprise the use of a Green Energy Tags for green energy based and produced goods through a renewable energy source, Yellow Energy Tags for partial use of green energy for the production of the goods and Red Energy Tags to show that the packaged good has been produced using 100% fossil fuels. The colored energy tags will also be used to label the salt, sugar and fat content of the goods. The labeling of goods in this manner provides the consumer with the information needed for them to make the right choices when purchasing the goods. Such labeling also helps the consumer to get used to buying goods in GDEC units as compared to the respective paper/fiat currencies used in their countries. It also provides an incentive for governments and the manufacturing entities of these goods to come up with more efficient and green production methods to minimize energy consumption when producing the goods. Independent energy agencies and/or physical institutes will execute quantification of energy needed for production of 1 unit of good and its package. In the first stages, these measurements should be coordinated with production companies on a voluntary basis. Further steps will then be taken to provide incentives for the governments of different countries to introduce this measuring and labeling system. It should be emphasized that measured kWh energy units for the productions of 1 unit of goods and their packages include all raw materials involved in the production process including their processing steps and transportation.

Refunds for packaged goods would be in fiat currency and GDEC units gathered from the barcodes and/or Energy Tags. The Energy Tags would indicate the energy units in kWh used for production of unpackaged goods as well. Here the energy tags will relate to weight, volume or one unit of unpackaged good. Automatic machines with the ability to read the Energy Tags of the packages and calculate the amount in GDEC units as well as in fiat currency will be provided. In the long term, this idea should be implemented on imported goods as well if this business model should become widespread in many countries. The trading countries and entities should undertake the necessary harmonization required in the different fields.

An Energy Audit System (EAS) using different colors of energy labels together with a specific examination certificate will be issued for projects to indicate their level of adaption to green production methods and detachment from fossil fuel production methods. Projects included in this energy audit system will be construction projects, agricultural projects, industrial projects, car industry, energy production industry, aviation industry and practically all branches of production industry as well as all branches of the service industry. The examinations and issue of certifications will be executed through the independent, State-recognized Audit Systems together with Independent Energy Agencies (IEA). In the use of Energy Tags and Audit Systems, all energy and health aspects will be considered. Audit system, Energy Tags and Traceability will introduce a full inventory of all branches of the economy.

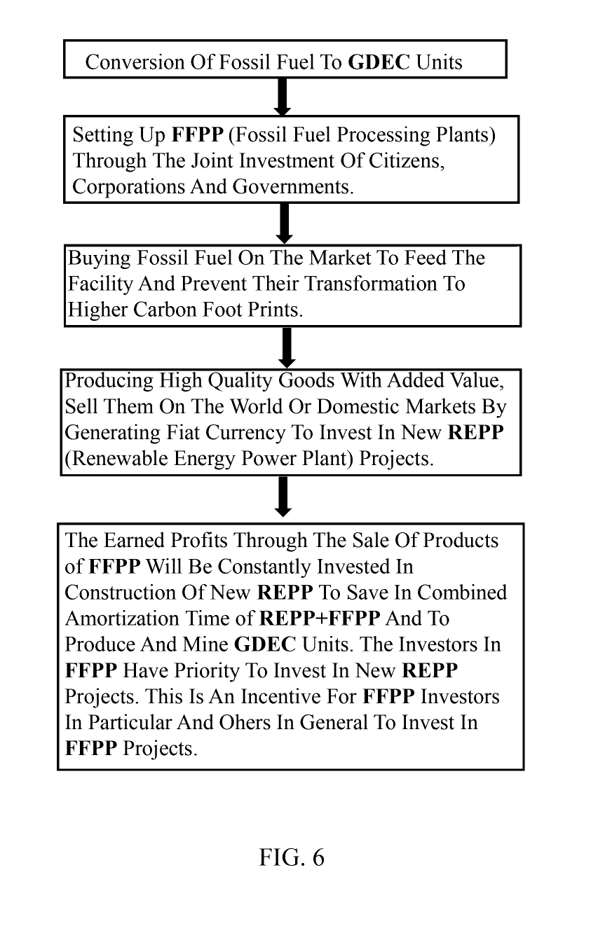

FIG. 6 is an overview of the conversion of Fossil fuels to GDEC units. Converting Fossil fuel to renewable energy before being burnt to CO2 by converting them to GDEC units is another aspect of the invention. It provides incentives and priorities to investors who have invested paper/fiat currency in Fossil Fuel Processing Plants (FFPP) to invest in the next planned REPP to generate renewable energy production based on GDEC units which will form the future currency in the world economic systems. The owners and investors of FFPP will become investors in REPP too because the FFPP profits must flow into creation of REPP projects before generating GDEC units and landing in the EW of investors. This will save time and raise the profit of their invested money. The earned profits through the sale of products of FFPP will be constantly invested in construction of new REPP to save in combined amortization time of REPP+FFPP and to produce and mine GDEC units. The Investors in FFPP have priority to invest in new REPP projects. This is an incentive for FFPP investors in particular and others in general to invest in FFPP projects. At the time of amortization of FFPP the REPP would have begun to work and the combined amortization times of the FFPP and the REPP can thus be reduced.

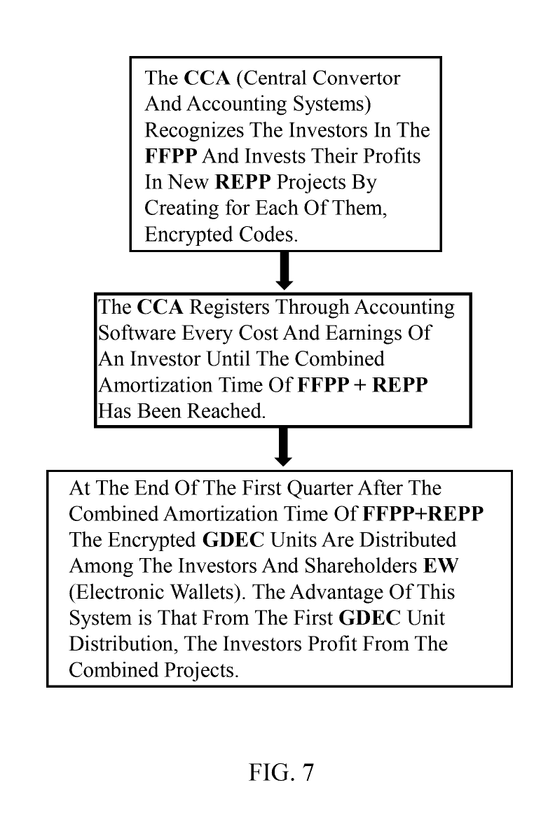

FIG. 7 is an overview of the role of the CCA in linking investors in FFPP to the REPP projects. The CCA recognizes the investors in the FFPP and invests their profits in new REPP projects by creating for each of them, encrypted codes. The encrypted codes for investors in FFPP will be recognized through the CCA and by planning new REPP projects, the earned amount of fiat currency from FFPP is converted to kWh energy units and invested automatically in the new REPP projects through the CCA. At the end of the first quarter after the combined amortization time of FFPP+REPP, the encrypted GDEC units are distributed among the investors and shareholders EW. The advantage of this system is that, from the first GDEC unit distribution, the investors profit from the combined projects.

It is not just the FFPP investors who have priority to invest in REPP projects but other investors are also assigned as investors in REPP projects. This leads to a shorter combined amortization time of FFPP and REPP and faster payout time for all investors. That means that the earnings of FFPP investors in fiat currency could flow into creation of many REPP projects. This will be a very useful incentive for investors in FFPP to invest in REPP. The goal is to promote re-directing fossil fuels into branches of industry like petro chemical, nanotechnology or biotechnology industry with the proven potential to produce added value for the economy creating highly qualified jobs and avoiding the production of fossil fuel based carbon dioxide CO2 which has been established as the major reason for global warming. The fiat currency thus earned would be invested in new REPP projects to generate more kWh energy units and therefore GDEC units. The use of Renewable Energy in FFPP's for processing the fossil fuels has the highest priority. That means in regions where there is not enough sunlight during the day, other forms of renewable energies like bioenergy or geothermal heat should be taken into consideration to cover the energy need in FFPP's.

An important condition for implementation of this idea is to build capacities and infrastructures for processing fossil fuels such as petrochemical industries, nanotechnology, biotechnology and other relevant branches of industry. Such infrastructures can be built with citizens, corporations and the government's capital in a joint investment program. As in the case of REPP projects, citizens are the main investors and owners of FFPP with the exception that here up to 50% or more of investment can be done through corporations and governments due to the urgent need for elimination of fossil fuels from the economic cycle. Like the REPP projects every constructed FFPP will have a unique code given to it by the CCA. The investor's code and the unique FFPP code will be combined to form an encrypted code unique for every investor. Investment sum in fiat currency divided through the fixed price for 1 kWh energy which is equal to 1 GDEC unit will deliver the amount of encrypted GDEC units to every investor at the time of inauguration of the factory. The investors in the FFPP will be owners of the GDEC units thus converted. Just as with the REPP projects, the first GDEC units will be distributed among the investor's electronic wallets (EW) at the end of the first quarter, after the combined amortization times of the FFPP and REPP.

The main advantages of the above idea are, 1) Creation of fossil fuel processing capacity through citizens, corporations and governments 2) Creating additional, highly qualified specialists in the fields of petrochemical, nanotechnology and biochemical industry 3) Preventing additional CO2 production by simultaneously producing products with added value within the economy and fixing the carbon in them, 4) Contribution to research for more high tech and strategic products like, more efficient solar cells or medicine products and equipment. 5) Creating more sustainable wealth throughout the economical branches by direct participation of citizens in prosperity, thereby overcoming poverty and preventing wars, especially in third world and/or developing countries, 6) Reinvesting the earned profits to add more capacity to REPP projects by constructing more of them to prevent using fossil fuels while at the same time transforming and recycling more fiat currency into REPP projects and generating GDEC units.

The business model of the invention envisions the creation and set up of Solar Parks as future communities and cities based on green and renewable energy standards. Components of such a Solar Park include, 1) Buildings with full exploitation of passive and active renewable energy construction techniques, 2) Charging stations for electric vehicles in strategic and important public places like house parking garages, public parking places, shopping centers and street parking zones and on the roads between the cities, 3) High-density mobile storage systems for storage of overcapacity of REPP's to use them in winter, during the night, selling them to other energy customers through the neighboring public grid, or by transporting them to desired points. At least two such storage systems should be interconnected. By taking and transporting first storage system, the second storage system will be ready to keep storing the produced energy, 4) System introduced automatic machines for payment of parking charge and vehicle charging station charge. All these are connected online with system owned bank, SOBS and can accept GDEC as well as fiat currency. The customer has the choice to pay with fiat currency or with GDEC available in his/her electronic wallet (EW). In the not too distant future, by the widespread use of GPS-positioned smart phones and devices, there will not be any need for such fixed, installed automats anymore. Similarly, the meaning and functioning of the Banks will be very different than it is today due to increasingly mobile and GPS protected transactions. 5) Urban-gardening, integrated in buildings and streets to ensure food security for the community and beyond. This is especially important during natural or non-natural crisis times, 6) Tree planting, fountains, artificial trees and artificial river construction as temperature sinks in the summer and as humidity creators for the whole community, 7) Integration of traditional Persian wind catchers in modem and adapted form as natural passive Air Conditioning systems as well as Persian Ghanat (underground water canalization systems to prevent evaporation in hot regions). 8) Combined REPP and green agricultural projects in the case of low growing plants to increase the efficiency of projects in the same land area and prevent agricultural land becoming arid, 9) All businesses run in a solar park as a community must offer at least one functional electronic payment system with ability to communicate with the CCA and system owned bank, SOBS and accept GDEC units as currency. At least one smart device should be available in every business to give to the customers the opportunity to log in and initiate the transaction. System owned bank, SOBS will be connected to the whole banking system and can execute transactions and exchange data with them, 10) All installed objects and systems within the Solar Parks are connected to the best smart energy management system available, to guarantee the smart and efficient use of energy and redirecting it to the points most needed. One of its most important tasks is to redirect the energy to high-density mobile storage systems where they can be stored, shared and used in critical and needed times, 11) Electric Railways System will be installed along zebra crossings near the homes and streets throughout the city's network of streets for delivering packages to and from the post office and other retailers. They will be connected to the electricity grid of the Solar Park, too. They can be designed and integrated into the landscaping to avoid unnecessary barriers that could spoil the landscape's look as a whole. The railways system would be able to transport persons and house animals in specially developed seats. Through a smart management system the packages or seats could be sent to the desired points where they are needed. 12) Recycling of packages and other materials have to undergo the audit system, too. This means that the recycling process must happen in mid and long term through the use of renewable energy. 13) Overproduction and/or surplus energy will be used to charge the batteries of the various solar applications and distribution to the battery stations and mobile distribution units as well as by any other mediums used as storage systems in times of need.

All businesses introduced in Solar Parks or elsewhere, will offer smart electronic devices, which are able to read and recognize the GDEC units as well as credit cards. It is assumed that Wi-Fi and Internet connection would be available in these Solar Parks and other locations. The businesses operating in these parks will accept fiat currency through bank account transfer only, but no fiat/paper currency will be accepted in cash unless the identity of customers are verified. But with the time, the whole system will move towards a cashless economy. These businesses will be connected to the SOBS or to the other EBS, which exchange data with CCA and/or SOBS. The transfer of fiat currency must be confirmed through the customer and retailer of these businesses online, so that it can be registered and transferred in the next step to the system owned bank, SOBS and further to new FFPP or REPP construction. This guarantees that the spent money in fiat currency has found its way back to the system and is converted to kWh energy units or GDEC units. Environmentally conscious retailers will agree to discount some percentage of the shopping amount to be invested in REPP projects in the name of the customer. A point or award system for buying green products is another envisioned concept for this invention. The collected points or royalties will be invested in the name of the owner in the REPP's or FFPP's. An advantage of the Solar Parks is that compared to the huge centralized energy provider systems, these parks are much less vulnerable and much faster to replace in the case of destruction through natural disasters or terrorist attacks. Therefore, establishing many Solar Parks as autonomous communities guarantees a much higher level of security to a higher number of citizens.

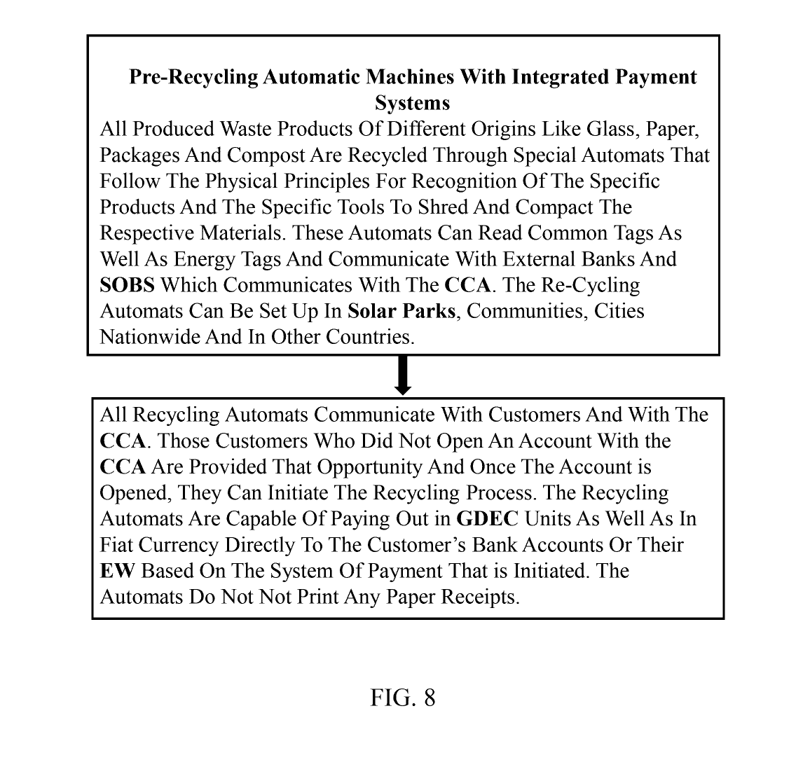

FIG. 8 is an outline of the concept of the Decentralized pre recycling Systems. Automatic recycle machines for different waste materials will be set up within the Solar Park community area as well as in different crowded places throughout the city like underground stations, touristic areas, parks, sport stadiums and arenas and railway stations to accept the packages. Before using the recycling automats, an account can and should be opened if the customer didn't open one already. All recycling automats are connected to SOBS and to various house banks of users and to the CCA and connected to the internet and wireless networks so that opening an account is easy from any place. The Energy Tags will be read to calculate the price in fiat currency as well as in GDEC units and transferring them to the account or wallet of the user. The user of the automatic recycling machine has the choice to pay in fiat currency through his/her house bank account or have the amount calculated in GDEC units on their electronic wallet. These recycling automats will not print any paper to, protect the environment from discarded paper. In case of technical problems regarding the transaction, the calculated amount can be saved on the account of the customer and by a later use of the recycling automats, be added and transferred to his accounts. These recycling automats are decentralized pre recycling machines equipped with devices to press or cut the packages in pieces to save volume and accept more packages before they are emptied and transported for further processing to recycling factories. These decentralized pre-recycling machines will be constructed for all sorts of materials and not only packages as described above. So, part of this invented business model is the introduction of decentralized pre recycling machines for paper treatment, glass treatment, plastic bottle treatment, compost treatment and many materials more. The pre-treatment step includes shredding and compressing of materials to save volume and use the full capacity of the space. In the case of compost recycling only one step of pre-treatment for shredding is needed to avoid smell development. In addition to that, the space for compost recycling machines should be air tight to avoid the smell penetration to the outside. To avoid the gas development especially in warm countries, they should be transported more frequently for further processing. Another solution is to maintain the system by educated personal to add wood shredder and soil to produce the end product, peat or compost for further use in agriculture or gardening.

Beside these automatic-recycling machines for recycling packages and as a new source of fiat currency to be invested in REPP projects, an online second-hand platform will be set up in order to accept all sorts of second hand electronic devices and all other valuable and useful second hand articles. The condition to participate in this online second-hand business platform is to invest the revenues in REPP projects. No money in the form of fiat currency will be transferred to the accounts of customers who offer their article for sale on this online second-hand platform. The platform serves as a mediator to sell the goods of customers, accept the fiat currency, reduce the tax, reduce the online business maintenance fees, reduce a minimum fixed fee for every article sold and transfer the amount of fiat currency together with important information about the customer to SOBS. The SOBS shares the data with the CCA which will open an investment account in the customer's name by converting the amount of fiat currency to kWh energy units, which is equal to the same number of GDEC units.

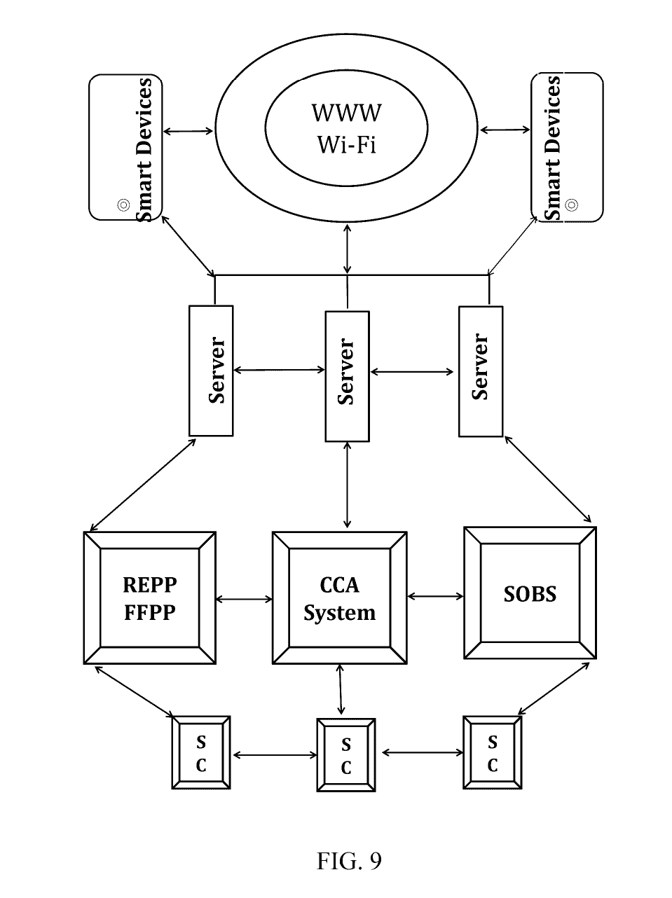

FIG. 9 is an overview of the technical infra structure of the system of the invention. When an investor wants to open an investment account through the system, they are first directed to the main website of the company and are provided guidance on how to open a secure SOB account using smart devices or system computers (SC) and the connections are made through the World Wide Web (WWW), Wireless Fidelity (Wi-Fi)/Wireless Internet and Servers connected to the WWW. After an investor opens a secure account, they are able to transfer funds from their bank accounts to the SOB account. Once the secure accounts have been successfully opened, every investor is the owner of at least one Electronic wallet (EW) where all GDEC units will be transferred and stored at the end of each quarter. Quarterly distributions of all GDEC units go directly to the EW of the investors. Every investor can organize his GDEC units in one or many wallets. The Bank sends the information about the amount of invested fiat currency and other important data to the CCA which then processes and stores the data. Payments can be made using smart phones and other smart devices.

When a company or investors want to open an account using an External Banking System (EBS), that banking system will be cooperating fully with the system by exchanging data with it through special software. The necessary project codes needed from the bank would be transferred online through the CCA by using secure online protocols. However, if an external bank detached from the system is going to open the account for citizens and investors, no data is transferred between the external bank and the CCA which means the investor must take the code for investing in the desired REPP or FFPP projects from the main website of the company before opening an account by that external bank. The receipt of invested fiat currency with the REPP project code on it will be mailed by the investor to the company and will be processed further. The bank sends the necessary information about the new account holder or investor to the company. Working with a totally detached external bank is a provisional solution until the business model has created enough REPP and/or FFPP projects to be able to set up its own SOBS. A system owned bank is technically and economically the best solution.

The CCA system is composed of many computers and servers worldwide that are interconnected to one another and can function online as well as offline. The main tasks of the CCA system are, converting the fiat currency of investors to kWh energy units and later to encrypted GDEC units by building an encrypted code composed of the REPP project code unique for every individual REPP and investor's code, matched to the profile of every investor. The basis for conversion is that 1 kWh energy unit equals to 1 GDEC unit. Through this encrypted code, the investors and REPP are connected to each other through the entire life of the GDEC units. Every investor can invest in as many REPP projects as possible but for every new investment in a new REPP project, an investor will be assigned a unique encrypted code. Investing in three REPP projects would mean having three encrypted codes in the electronic wallet (EW) of an investor with the number of GDEC units corresponding to each of them. At the end of the first quarter after the amortization time of the REPP, all the produced, mined, converted and encrypted GDEC units will be transferred to the EW of investors. These encrypted codes are crucial for proper functioning of the principles of Inheritance and Traceability.

The CCA will have online contact with all the important governmental and non-governmental entities such as the tax authorities, local, countrywide and world banking systems and through the system owned smart applications, online contact to investors. The CCA will collect all necessary information related to the account information of the investors, transactions within GDEC community, real time registration of produced kWh energy units through the REPP, their encryption to encrypted GDEC units and their distribution to the EW of investors. The CCA will also collect all necessary information related to transactions between GDEC community and retailers, as long as they take part in the program. As the central unit, it will be connected to all existing REPP projects worldwide and offer all available information about them to users. Additionally, through interconnectivity with SOBS, the CCA will be connected to all the banking systems within a country and the world banking system. At the end of each quarter and before distribution of GDEC units to the electronic wallets (EW) of investors, 10% of produced and mined kWh energy units will be kept back by the CCA in the SOBS to secure further investment in new REPP projects as well as to cover unpredicted costs. Special accounting software's will allow the system to issue quarterly reports that will show the performance of the whole system.

Exchange of data with the CCA includes all necessary information about the goods that have been sold in exchange for the GDEC units. The information matched to a certain good is saved on their barcodes or Energy Tags. So, the combination of encrypted GDEC units and data exchange with retailers can guarantee a high level of transparency and traceability of the GDEC units and goods. Voluntary cooperation by the retailers, sellers and the rest who participate in the economy is very crucial for full functioning of this invention. They should accept GDEC as a currency to enable the transaction between the buyer and the rest of the economy. Traceability of GDEC during transactions in the marketplace is very crucial for preventing fraud and tracing them back during their whole economic life Inheritance and traceability cannot be controlled and minimized. However, their implementation through encrypted GDEC units can, and will lead to minimization and control of inflation and fraud.

Every REPP is GPS located so that through special hardware and software the renewable energy production can be monitored online. Through the CCA, the registered state of production can be followed online through all Internet or Wi-Fi connected devices as well as smart devices through later described invention-related Apps. All the important information is shown online. The REPP projects and connected utility users should be interconnected through a smart energy consumption and storage system to ensure the most efficient use of produced and mined energy units. Therefore, high-density mobile storage systems are very crucial to achieve maximum efficiency for autonomous REPP projects. The proximity to public grid should be integrated into any REPP construction in the form of energy counter installations from and to the REPP to increase the energy delivery security. Other, state of the art technical solutions or combinations of them should be put into consideration by planning and constructing a new REPP. The construction of REPP projects can be executed through external companies, too. A very important condition for them to execute the construction contract is to invest 10% of their after tax earned amount of fiat currency, into this business model.

Invention-related Applications (Apps) will be used to allow the users full access to the site for opening a new account, transferring and receiving GDEC units through their electronic wallets (EW), take part in online GDEC units auction and trade platforms, check in real time, the energy production level of any REPP project, pay their energy bill with fiat currency or GDEC units, re-convert their GDEC units to fiat currency if they wish to, re-invest in another REPP project and to be connected with social media by exchanging community related opinions and beyond.

Another aim of this business model is to turn gambling into REPP projects thereby transforming negative socio-economic energy to environmentally positive and profitable projects for everyone, with the end product as, GDEC units. Huge economic resources are lost by engaging in negative economic activities like gambling which lead to social destruction, addiction to drugs, divorce, murder and other negative impacts on the economy. The idea is to turn a part of the huge amount of money lost during gambling to positive energy by investing 25% from the loss or win from gambling into production of renewable energy power plants REPP or FFPP or both. The idea should be first implemented on online gambling sites and in a next step be extended to all gambling activities through government laws. The gambler agrees to open a gambling account to invest 25% of his win into renewable energy projects. His money isn't confiscated but invested for him as a normal investor to profit from the system and contribute to his own wealth by avoiding a total bankruptcy if addicted to gambling. In return, the runner and owner of the gambling business agrees to invest 25% of the lost money of the gambler, in the same project. This 25% of the gamblers lost money will be invested in REPP projects and functions as a credit. At the end of the first quarter after the amortization time, the 25% amount of money will be given back to the owner of the gambling company through the investor or former gambler. The interest rates are at an optimum level in order to compensate the invested money through the owner of the gambling business. Positive advantages of this scheme are, the prevention of total bankruptcy of the gambler and turning his attention towards much more positive activities within the society to maybe giving up one day gambling totally. The gambling business owner also would have fulfilled his responsibility towards the community and can continue his business with a purer conscience than before. This business idea model as part of the invention could be applied to many other similar fields, too.

There are many negative energy fields within the socio-economic world we are living in which could be transformed according to the idea of this invention to positive socio-economic energy. For example, a certain percentage of the confiscated illegal capital owned by drug dealers could be invested in this business model, too. The invested sum of fiat currency belonging to former drug dealers can be invested in REPP projects in the name of those innocent people who were hurt in various forms through the activities of drug dealers. Here, instead of punishing the drug dealer, he/she could be involved in new projects as a creditor. At the end of the first quarter after amortization time, his money can be paid back with an optimum interest rate.

Another goal of this business model is to provide an online auction and trading platform for GDEC units. Based on the lifetime of REPP and growth potential of GDEC units, the citizens of the world or citizens within a country can trade the GDEC units for higher prices than the given fixed price through the Energy Agency Authority IEA for each year. This trade and exchange of GDEC units will happen on the basis of offer and demand in the free market and will be executed if the profit margin for trading them is high enough, which should normally be the case due to the high profit margin and longevity of the REPP. The GDEC units have an inherent potential of growth over the lifetime of REPP's. After a widespread period of REPP projects and mined GDEC units, there will be a natural period of slowdown in the construction of new REPP projects which will make the existing investors, owners of valuable GDEC units with a high profit margin and multiplication potential. The new investors can go online and participate in real time online auctions or online trading platforms to buy some GDEC units from other investors thereby, inheriting them. They know that by acquiring and inheriting some GDEC units they directly participate in the wealth produced and mined by REPP projects or other mentioned projects through the Inheritance Principle (IP).

Construction of producing factories and building complexes based on Renewable Energy power. The potential of this business model through construction of REPP projects as energy producer can be extended to set up energy autonomous factories in the production sectors and constructing building complexes with fully solar architecture, exploiting the full potential of the outer facade of buildings. Using solar panels and materials with higher energy density would reduce the construction space and increase the production capacity in the same area.

System introduced ATM machines for exchanging GDEC units against gold, silver and other rare metals. This business model of the invention envisions the use of special ATM machines for exchanging the GDEC units generated against other commodities like gold, silver and other rare metals. The parties who offer the commodities, should be registered in advance in order to be listed on the CCA and the SOBS. If these metals are not available in the ATM machines at a given time, a secure and encrypted code will be provided to the customer to be able to complete the transaction at a later time or contact the source of the rare metal and finish the transaction there. Compared to ATM cash machines the number of these ATM machines will be very limited and placed in crowded areas like shopping malls, train stations, and business centers.

The end goal of the current invention is to get the various economies to stop accepting paper or fiat currency and to change to an electronic wallet (EW) system and use GDEC as the unit of currency. All participants in transactions within this business model have to open a bank account with the System Owned Banking System (SOBS) in addition to their external house bank accounts (EBS) and acquire at least one electronic wallet (EW) to be able to participate in this model. As can be seen, this invented business model with the various ideas and incentives built into it can have a huge positive transformation potential to turn and recycle the inflation prone and unstable paper/fiat currencies to a positive socio-economic power with the GDEC units as inflation and fraud-proof end products. Our solar system is currently at half of its life span and is rich enough to provide us with Renewable Energy for centuries to come. Nuclear power and fossil fuel based economies are not sustainable and condemned to fail by causing more destruction and war. All World Citizens should help to form a new paradigm based on a sustainable and Renewable Energy driven economy with GDEC units as a liberal and people based currency. Based on GDEC units as generated in this business model, various financial products can and will be developed and introduced in order to help the widespread use of this invention. Security measures and tools will ensure the security of the system components and the entire GDEC connected community.

The foregoing description of the present invention through its figures and preferred embodiments should not be construed to limit the scope of the invention. It is to be understood that the embodiments of the present invention as described herein do not limit any application or scope of the invention and that the invention can be carried out and practiced in various ways and implemented in embodiments other than the ones outlined in the description above. It is to be further understood that the phraseology and terminology used to describe the invention are for descriptive purposes only. It should be understood and obvious to one skilled in the art that alternatives, modifications, and variations of the embodiments of the present invention may be construed as being within the spirit and scope of the appended claims.

What is claimed is:

1. A system for the generation of a world currency, said system comprising:
a global digital energy currency;
said global digital energy currency generated from an energy produced from a renewable energy power plant;
said energy produced from said renewable energy power plant is a kilowatt hour energy;
wherein said renewable energy power plant is constructed using a paper currency of a plurality of investors;
said plurality of investors deposit said paper currency in a system owned bank;
said system owned bank connected to a central converting and accounting system;
said system owned bank sends said paper currency of said plurality of investors to said central converting and accounting system;
said renewable energy power plant sends a data of said kilowatt hour energy produced from said renewable energy power plant to said central converting and accounting system;
wherein said central converting and accounting system converts said data of said kilowatt hour energy to said global digital energy currency;
said central converting and accounting system converts said paper currency of said plurality of investors to said global digital energy currency units through encryption; and
distributes said encrypted global digital energy currency to an electronic wallet of said plurality of investors.

2. The system for the generation of a world currency as described in claim 1 wherein a unit of said global digital energy currency is equal to one unit of said kilowatt hour energy produced by said renewable energy power plant.

3. The system for the generation of a world currency as described in claim 1 wherein said encrypted global digital energy currency is comprised of one part identifying the project of said renewable energy power plant and a second part identifying an investor of said renewable energy power plant such that the two parts are linked together and therefore traceable.

4. The system for the generation of a world currency as described in claim 1 wherein after deduction of all costs for the renewable energy power plant project, accumulated global digital energy currency are distributed to the electronic wallets of the investors in the project to be used for transactions in the marketplace, to exchange the global digital energy currency for goods and services, thereby transferring the global digital currency units to other citizens and investors making them inheritors of the global digital energy currency.

5. The system for the generation of a world currency as described in claim 1 wherein the energy produced by the renewable energy power plants is sold through the public grid to users who pay for the kilowatt hour energy in paper currency to the utility companies or the system owned banking system and the central converting and accounting system converts the paper currency into global digital energy currency for the next quarterly distribution among the investors and citizens.

6. The system for the generation of a world currency as described in claim 1 wherein investors in the renewable energy power plant projects have a choice to stay in the system and accumulate more units of global digital energy currency at the end of each quarter or reconvert their global digital energy currency to paper currency.

7. The system for the generation of a world currency as described in claim 1 wherein to spread the global digital currency throughout the economy, within the first three years, thirty percent of quarterly distributed global digital energy currency units change their ownership with new investors to bring in the new investors as inheritors of the global digital energy currency.

8. The system for the generation of a world currency as described in claim 1 wherein the global digital energy currency is adopted by green retailers followed by other retailers for the widespread use of the global digital energy currency through the economic system.

9. The system for the generation of a world currency as described in claim 1 wherein the system uses energy tags in colors, green for products produced through renewable energy sources, yellow for products produced through partial use of renewable energy sources and red for products produced mainly through fossil fuels.

10. The system for the generation of a world currency as described in claim 1 wherein energy tags in colors are combined with health parameters such as salt, sugar, fat and a plurality of nutrient content in products to introduce a combined energy and health label system for all products within the economy of all nations worldwide.

11. The system for the generation of a world currency as described in claim 1 wherein an energy audit system issues certifications using different colors of energy labels such as green, yellow and red for all branches of industry including the service industry based on their level of adaption to green production methods and detachment from fossil fuel production methods.

12. The system for the generation of a world currency as described in claim 1 wherein citizens and investors in fossil fuel processing plants invest their earned profits through the sale of products of the fossil fuel processing plants into the construction of renewable energy power plants to generate the global digital energy currency.

13. The system for the generation of a world currency as described in claim 1 wherein solar parks are created using renewable energy standards and use of global digital energy currency.

14. The system for the generation of a world currency as described in claim 1 wherein factories and buildings are constructed using renewable energy generated power from the renewable energy power plants for the generation of global digital energy currency.

15. The system for the generation of a world currency as described in claim 1 wherein recycling automatic machines are set up to accept global digital energy currency.

16. The system for the generation of a world currency as described in claim 1 wherein a plurality of loss or win from gambling is invested in renewable energy power plants to generate global digital energy currency.

17. The system for the generation of a world currency as described in claim 1 wherein the global digital energy currency is traded on an online auction and trading platform so that citizens and investors can participate in real time online auctions and online trading platforms to buy global digital energy currency from other investors and thereby, inheriting the said currency.

18. A method for generating a global digital energy currency said method comprising:
1) citizens and investors depositing paper currency in system owned banking systems for investment in renewable energy power plant projects;
2) planning and construction of a plurality of renewable energy power plants using said paper currency deposited by said citizens and investors;
3) said plurality of renewable energy power plants sending kilowatt hour energy data generated by said plants to a central converting and accounting system;
4) said central converting and accounting system converts said paper currency of said citizens and investors to said global digital energy currency using said kilowatt hour energy data from said plurality of renewable energy power plants; and
5) depositing said global digital energy currency into the electronic wallets of said citizens and investors for transactions in the marketplace.

19. The method for generating a global digital energy currency as described in claim 18 wherein the global digital currency is encrypted with codes linking the global digital energy currency with citizens and investors of the renewable energy power plant projects so that the global digital energy currency is traceable.

20. The method for generating a global digital energy currency as described in claim 18 wherein citizens and investors exchange their ownership of the global digital energy currency with new citizens and investors as inheritors of the global digital energy currency to spread the currency through the economic system.

21. The method for generating a global digital energy currency as described in claim 18 wherein citizens and investors who invest in fossil fuel processing plants invest in renewable energy power plants to generate the global digital energy currency.

22. The method for generating a global digital energy currency as described in claim 18 wherein said paper currency is generated from system defined and owned businesses to invest in renewable energy power plants and fossil fuel processing plants.
